(19) United States
(12) Patent Application Publication
(10) Pub. No.: US 2003/0167217 A1
(43) Pub. Date: Sep. 4, 2003

(54) Method and apparatus for capitalizing assets

(76) Inventors: Vincent Formale, Southington, CT (US); Bradford Leon Houck, Raleigh, NC (US); Paul Chirstian Iverson, New Milford, CT (US); Deron John Rossi, Cary, NC (US); Daniel J. Scollins, Lincolndale, NY (US); Gerald P. Tieskoetter, Raleigh, NC (US)

Correspondence Address: Synnestvedt & Lechner LLP, 2600 Aramark Tower, 1101 Market Street, Philadelphia, PA, 19107, US

(21) Appl. No.: 10/087,627

(22) Filed: Mar. 1, 2002

(51) Int. Cl. G06F 17/60

(52) U.S. Cl. 705/30

(57) ABSTRACT

The invention is a method and apparatus that can be implemented as an automated process by software for classifying assets, preferably at the time of acquisition, as capital assets or expensed assets. Assets are classified as capital or expensed assets by determining the average cost of all models of a given machine type as of a predetermined date, preferably, the date that the machine type is released for commercial sale. That average cost is then compared to a predetermined minimum value and all assets of a machine type the average value of which is greater than or equal to the minimum cap value are classified as capital assets while all assets of a machine type the average value of which is below the minimum cap value are classified as expensed assets.

### FIELD OF THE INVENTION

The invention pertains to fixed asset accounting. More particularly, the invention relates to the categorization of assets as capitalized assets and expensed assets for financial reporting, tax reporting and/or insurance value reporting purposes.

### BACKGROUND OF THE INVENTION

Tax paying entities, including corporations and other large entities, usually categorize assets for financial reporting and tax purposes as either capital assets or expensed assets. Assets are physical properties, including real property and personal property, that typically have a defined value. In addition to financial reporting, the laws and regulations of most governments allow the acquisition costs associated with assets to be treated differently for tax purposes depending on whether the tax paying entity classifies the asset as a capital asset or an expensed asset.

Under the United States tax code, for instance, corporations typically can deduct the cost of business assets from their income in determining taxable profits of the corporation in a given tax reporting year. Expensed assets are deducted entirely in the year in which they are purchased. Capitalized assets, on the other hand, are depreciated over a number of years, rather than being deducted for tax purposes in the year of purchase.

Capitalized fixed assets usually, but not necessarily, are higher cost items and/or items that have a useful life of at least several years. Typical capitalized assets include land, buildings, office equipment, computers, furniture, machinery, motor vehicles, etc. Expensed assets typically, but not necessarily, are assets of lower individual value, assets that have a short useful life or assets that, by definition, are only temporally in the possession of the corporation (e.g., inventory). Many corporations do not track expensed assets as accurately as capitalized assets or at least track them in a different way.

The laws and regulations of most governments allow corporations and other entities significant leeway in terms of categorizing assets as capital or expensed assets, as long as the categorizations are consistent with generally accepted accounting principles. Therefore, corporations should have a definable set of criteria for classifying an asset as a capital or expensed asset, which criteria conform to generally accepted accounting principles. One generally accepted and very simple classification criterion is acquisition cost or value. That is, a corporation could reasonable decide to treat all assets with a purchase price exceeding some predetermined amount (sometimes termed a minimum capitalization or min cap amount) as capital assets and to treat all assets with a purchase price below the min cap amount as expensed assets. However, using such a simple criterion can lead to accounting difficulties, inconsistencies and/or departures from good accounting principles.

In practice, IT (Information Technology) equipment, such as computers, printers, monitors, telephones, is a particularly troublesome area with respect to such accounting principles because the cost and/or the useful life of such equipment tends to be near the normal cost and/or life expectancy cutoffs, respectively, that corporations commonly use for classifying assets as capital or expensed assets. Even further, both cost and life expectancy of IT equipment have been in a state of flux for years.

For example, if a certain type of asset has a value that can vary over a short period of time (e.g., less than a few years) and that value hovers around the min cap value, some such assets will end up being classified as capital assets, while other similar or even identical assets will end up being classified as expensed assets. Not only are such inconsistencies generally not in accord with good accounting principles, but they may adversely affect other automated data processing tasks that are performed with respect to such assets.

More particularly, fixed asset accounting for large entities such as corporations usually is performed at least in part by computers running various accounting software applications. These accounting software applications typically have access to one or more computer databases maintained by the corporation for accounting as well as other asset tracking purposes. Often, other software applications, including accounting-related and non-accounting-related software applications, access and use the same databases for other data processing purposes. Some of those applications may treat an asset differently depending on whether it is a capital asset or an expensed asset. Depending on the particular application, the fact that two similar or identical assets are classified differently could create significant errors in the data processing results.

Merely as an example, let us consider an example in which a corporation treats assets with a purchase price of $1.000.00 or greater as capital assets and assets with a purchase price of less than $1,000.00 as expensed assets. Personal Computers (PCs) that are used in typical office type environments commonly cost about $1,000.00 at this time. However, the prices of such PCs continue to drop rapidly. In addition, PCs are highly customizable, with each different customized PC having a slightly different price. Accordingly, a corporation could purchase two very similar PCs wherein one of the PCs has a purchase price over $1,000.00 and another almost identical PC has a purchase price below $1,000.00. Generally, it is preferable to treat these two almost-identical PCs the same way. However, the purchase price criterion mentioned above would cause one to be classified as a capital asset and the other to be classified as an expensed asset.

Therefore, it is an object of the present invention to provide a method and apparatus for consistently classifying assets as capital or expensed assets.

It is another object of the present invention to provide a method and apparatus for classifying assets as capital or expensed assets at the time of acquisition of the assets.

It is a further object of the present invention to provide an automated process for classifying assets as capital or expensed assets.

It is a further object of the present invention to provide an automated process for classifying assets as capital or expensed assets at the time of acquisition of the asset.

### SUMMARY OF THE INVENTION

The invention is a method and apparatus that can be implemented by software as an automated process for classifying assets, preferably at the time of acquisition, as capital assets or expensed assets. In accordance with a preferred embodiment of the invention, the processing of the purchase of assets for the corporation is entirely automated in that purchase orders are “paperless”. Specifically, all purchase order data and internal ordering data is input directly into a computer and stored in an asset management database (or table). The automated purchase orders and the database each include various fields for each asset that can be populated with appropriate data, if available. Such data fields include invoice number, purchase order number, purchase price, purchase date, delivery date, manufacturer, asset type, machine type, model number, serial number, intra-corporate purchasing entity, retailer, etc.

With respect to the machine type, model number, and serial number fields, the serial number usually is a unique number assigned to each individual item so that each individual item can be uniquely identified, whereas the model number is a generic number for all items of identical (or very similar) design. The machine type field is an even broader category that identifies the item by its type. Since many manufacturing companies use relatively standard machine type designations for their products (as well as model numbers and serial numbers), this field may be populated with the manufacturer's assigned machine type. Alternately, the acquiring corporation may have a predetermined list of machine types that it uses to populate the machine type field. The machine types may be relatively broad, such as monitors, printers, telecommunications devices, computers or relatively specific, such as computers with different generations CPU, e.g., 386, 486, Pentium, Pentium II, Pentium III, wherein all assets must be classified as one of the predetermined machine types.

In accordance with the invention, assets are classified as capital or expensed assets more consistently by determining the average cost of all models of a given machine type as of a predetermined date. In one preferred embodiment of the invention, that date is the date that the machine type is released into production for commercial sale. That average cost is then compared to a predetermined minimum value (e.g., a min cap value) and all assets of a machine type the average value of which is greater than or equal to the minimum cap value are classified as capital assets, while all assets of a machine type the average value of which is below the min cap value are classified as expensed assets. Alternately, all machine types for a given function (e.g., CPUs) may be classified as capital.

In this manner, the classification of individual assets as a capital or expensed asset is made more consistent and rational.

The software to implement the present invention preferably is integrated into a larger software system that includes software modules within which acquisitions of assets are recorded. Preferably, the inventive software is integrated with purchase order software modules, such as internal ordering systems and asset management databases, so that, when an asset is acquired, software in accordance with the present invention can automatically detect or be notified of a purchase order, access the necessary machine type data from the purchase order or an appropriate database and, after determining whether the asset is a capital or expensed asset, populate an asset type data field in a database with the appropriate value indicating whether the asset is a capital asset or an expensed asset.

### BRIEF DESCRIPTION OF THE DRAWINGS

FIG. 1 is a flow diagram illustrating operation in accordance with a first aspect of the present invention.

FIG. 2 is a flow diagram illustrating operation in accordance with a second aspect of the present invention.

### DETAILED DESCRIPTION OF THE INVENTION

In a preferred embodiment, the invention is implemented by software routines. However, the invention can be implemented by other techniques, including manually.

In accordance with the invention, assets are classified as capital assets or expensed assets as a function of the machine's designated purpose (e.g., CPUs) or its average price as of a predetermined date of all products of the same machine type as the particular asset of concern. More particularly, the predetermined average price of products of the particular machine type is compared to a minimum capitalization value decided upon by the corporation, e.g., $1000.00. The min cap value may be fixed or variable. All assets of a machine type for which the predetermined average cost is greater than or equal to the min cap amount are classified as capital assets and all assets of a machine type for which the average value on the determined date is below the minimum cap amount are classified as expensed assets. Generally, the min cap amount should be variable at least in the sense that it is adjusted, as necessary, at fixed intervals as a function inflation or cost of living increases or of the general market value of equipment of a certain type (e.g., computers). The fixed intervals might be annual or bi-annual or once a decade, as the case may be.

The predetermined date can be any reasonable date, such as the date that the machine type is released into commercial production. Alternately, it may be the date that the corporation first purchases an asset of the particular machine type. In an even further alternate embodiment, the date may be the date of the latest release of suggested retail prices for models of the particular machine type published by the manufacturer of the machine type.

The average price can be calculated in any reasonable manner. For instance, one may simply take all the different models under that machine type and, weight each model price evenly and take the average. Alternately, one may weight the values of the individual models based on anticipated or historical purchasing trends of the models or of the models of similar machine types. For instance, if a given machine type includes two models, one of which 80% of purchases of assets of that machine type by the corporation and the other of which has historically comprised 20% of purchases of that machine type by the corporation, the cost of each of those two models may be weighted 80% and 20%, respectively, in the averaging calculation. As an even further alternative, the average may be taken of only the particular models under the machine type that the corporation either has historically purchased or anticipates purchasing.

The invention is particularly suitable for use by a corporation (or other entity) that uses many of its own products as capital assets. For instance, the assignee of the present application is a computer hardware and software manufacturer. Further, in the course of carrying out its business, many of its employees utilize computer hardware and software to carry out their jobs. Accordingly, many of the corporation's capital assets, particularly of the IT type, are products of the corporation itself. Accordingly, in such a situation, the corporation has readily available all of the information necessary to practice the present invention, such as a complete list of all machines types, models under those machine types, suggested retail prices for those machines, and the commercial release date of that machine type. Furthermore, when the assets are products of the corporation itself, one may use the corporation's base manufacturing cost, rather than the suggested retail price, for calculating the average value/cost for machine types. If so, the min cap value may need to be adjusted accordingly.

Since many manufacturing companies use relatively standard machine type designations for their products, however, the invention can be readily applied in many situations where the assets are acquired from third party manufacturers and retailers. However, in an alternate embodiment of the invention particularly suitable for situations in which the capital assets of interest are largely or exclusively purchased from third parties, the machine type need not be a designated type by the manufacturer, but may be a machine type selected from a plurality of acceptable machine types designated by the corporation.

Implementing the present invention within the framework of a larger fixed asset management hardware and software system would involve integrating two distinct software modules into the system. The first module determines whether assets of a given machine type are to be capital assets or expensed assets. The second module reviews incoming ordering systems to extract the data in the machine type field from the purchase order (or other resources) and determines whether the asset on that invoice is to be treated as a capital asset or an expensed asset. Both software modules preferably are integrated into an overall fixed asset accounting hardware and software scheme so that each module can access corporate databases containing the data useful for implementation of the invention.

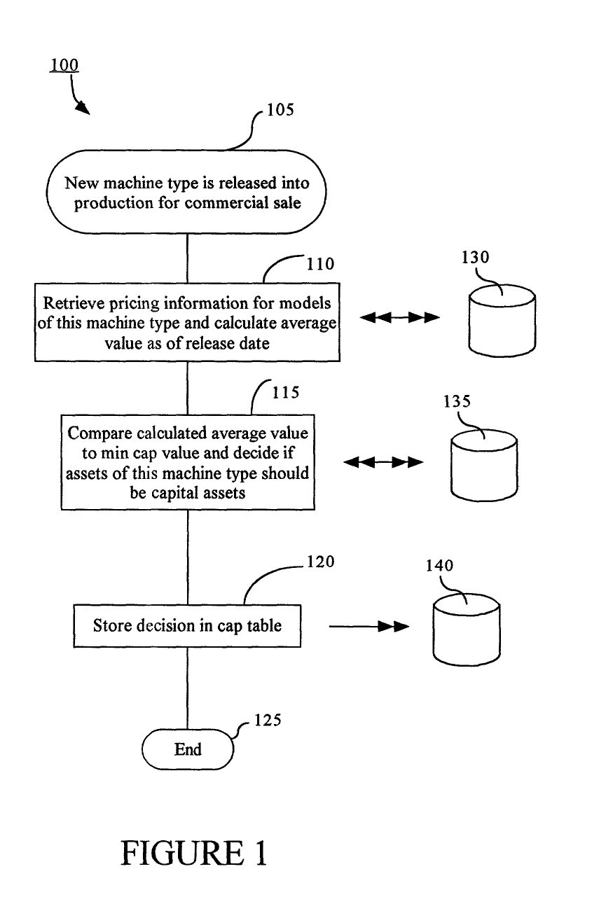

FIG. 1 is a flow diagram illustrating one exemplary embodiment of the first module 100 in accordance with the present invention, in which decisions are made as to whether assets of a given machine type are to be classified as capital assets or expensed assets. The process starts in step 105 when a new machine type is released into production for commercial sale. In a preferred embodiment of the invention, the data relating to that machine type, such as the models under that machine type and the manufacturer's suggested retail price for those models are available to the software module 100 in a database 130 that the module can access. In step 110, the module retrieves the data and runs an algorithm in accordance with whatever averaging scheme the corporation decides upon to derive an average value for models of that machine type. In step 115, it compares the average value derived in step 110 with the minimum capitalization value, which may be obtained from the same or a different database 135 accessible to the module 100. In step 120, it stores in a table or database 140 stored in memory (herein termed the cap table) data indicating that the machine type is a capital asset or an expensed asset. The process ends at step 125.

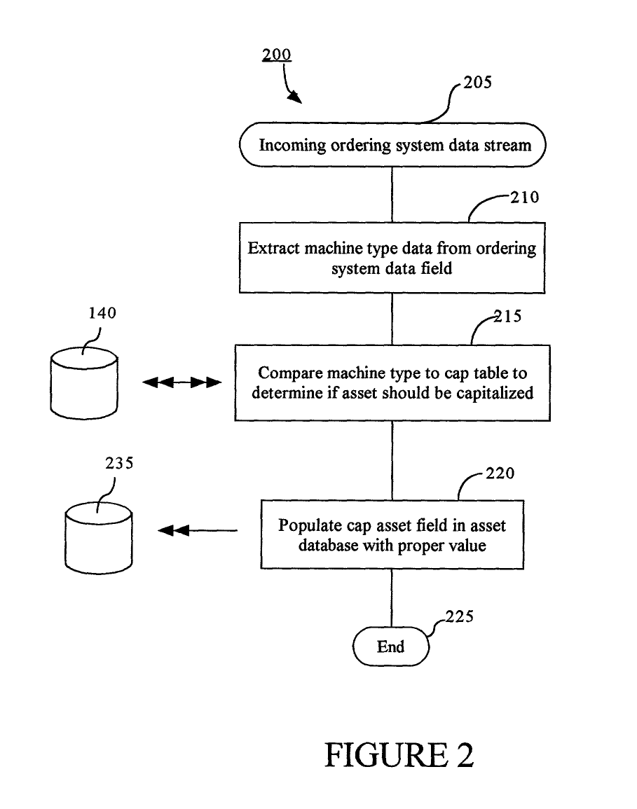

FIG. 2 is a flow chart illustrating operation in accordance with a preferred embodiment of the second aspect of the present invention. Particularly, in a preferred embodiment of the invention, the corporation's ordering system and purchase orders are automated and provided in a data stream to software module 200, as illustrated in step 205. In step 210, the module extracts the machine type data from the machine type field of the purchase order. In step 215, it matches up the machine type from the purchase order to a machine type in the cap table 140 to determine if assets of this machine type are capital assets or not. In step 220, it populates a capital asset field in a database 235 with the proper value indicating whether the asset is a capital asset or an expensed asset as determined in step 215. The process ends at step 225.

Thus, the invention provides a method and apparatus for classifying assets, preferably at the time of acquisition as capital or expensed assets, in accordance with a scheme that is more uniform and in accordance with good accounting principles.

Having thus described a few particular embodiments of the invention, various alterations, modifications, and improvements will readily occur to those skilled in the art. Such alterations, modifications and improvements as are made obvious by this disclosure are intended to be part of this description though not expressly stated herein, and are intended to be within the spirit and scope of the invention. Accordingly, the foregoing description is by way of example only, and not limiting. The invention is limited only as defined in the following claims and equivalents thereto.

We claim:

1. A method of classifying an asset as a capital asset or an expensed asset, said method comprising the steps of:
(1) assigning with respect to each of a plurality of machine types an average value of models of said machine type;
(2) selecting a minimum capitalization value;
(3) receiving data signifying the acquisition of an asset;
(4) determining a machine type of said acquired asset;
(5) correlating said machine type of said acquired asset to said average value assigned to said machine type in step (1); and
(6) if said average value for said machine type of said acquired asset is greater than or equal to said minimum capitalization value, classifying said asset as a capital asset and, if said average value for said machine type of said acquired asset is less than said minimum capitalization value, classifying said asset as an expensed asset.

2. The method of claim 1 wherein step (1) comprises, for each machine type, the steps of:
(1.1) determining all models of said of said machine type;
(1.2) determining a value of each of said models of said machine type;
(1.3) calculating an average value of said models of said machine type.

3. The method of claim 1 wherein step (1.3) comprises weighting said value of each model equally in said average calculation.

4. The method of claim 1 wherein step (1.3) comprises weighting said value of each model as a function of predicted purchasing trends of models of said machine type in said average calculation.

5. The method of claim 2 wherein said value of said models are derived from the manufacturer's suggested retail price of said model.

6. The method of claim 2 wherein said value of said models are derived from the manufacturer's base manufacturing cost for said model.

7. The method of claim 2 wherein step (1.2) comprises determining said values as of a predetermined date.

8. The method of claim 7 wherein said predetermined date is the date of commercial release of said machine type.

9. A computer readable product embodied on computer readable media readable by a computing device for classifying an asset as a capital asset or an expensed asset, said product comprising computer executable instructions for:
(1) assigning with respect to each of a plurality of machine types an average value of models of said machine type;
(2) storing said average values correlated with corresponding machine types in a first computer memory;
(3) storing a minimum capitalization value in a second computer memory;
(4) receiving purchase order data identifying the acquisition of an asset;
(5) reading a machine type field of said purchase order data;
(6) finding in said first memory said average value corresponding to said machine type in said machine type field of said purchase order data; and
(7) comparing said average value found in step (6) to said minimum capitalization value and, if said average value for said machine type of said acquired asset is greater than or equal to said minimum capitalization value, classifying said asset as a capital asset and, if said average value for said machine type of said acquired asset is less than said minimum capitalization value, classifying said asset as an expensed asset.

10. The computer program product of claim 9 wherein step (4) comprises receiving a data stream containing said purchase orders.

11. The computer program product of claim 10 wherein step (5) comprises reading said machine type out of a data field in said purchase order.

12. The method of claim 11 wherein step (1) comprises, for each machine type, the steps of:
(1.1) determining all models of said of said machine type;
(1.2) determining a value of each of said models of said machine type;
(1.3) calculating an average value of said models of said machine type.

13. The method of claim 12 wherein step (1.3) comprises weighting said value of each model equally in said average calculation.

14. The method of claim 12 wherein step (1.3) comprises weighting said value of each model as a function of predicted purchasing trends of models of said machine type in said average calculation.

15. The method of claim 12 wherein said value of said models are derived from the manufacturer's suggested retail price of said model.

16. The method of claim 12 wherein said value of said models are derived from the manufacturers base manufacturing cost for said model.

17. The method of claim 12 wherein step (1.2) comprises determining said values as of a predetermined date.

18. The method of claim 17 wherein said predetermined date is the date of commercial release of said machine type.
